(19) United States
(12) Patent Application Publication
(10) Pub. No.: US 2026/0052391 A1
(43) Pub. Date: Feb. 19, 2026

(54) NOTIFICATION SUBSCRIPTION METHOD AND APPARATUS, SUBSCRIPTION DETERMINATION METHOD AND APPARATUS, AND INFORMATION RECEIVING METHOD AND APPARATUS

(71) Applicant: BEIJING XIAOMI MOBILE SOFTWARE CO., LTD., Beijing (CH)

(72) Inventor: Wei LU, Beijing (CN)

(21) Appl. No.: 19/103,123

(22) PCT Filed: Aug. 12, 2022
(86) PCT No.: PCT/CN2022/111939

§ 371 Date: Feb. 11, 2025

(51) Int. Cl. H04W 12/37; H04W 4/02; H04W 8/22; H04W 64/00

(52) U.S. Cl. CPC H04W 12/37; H04W 4/02; H04W 8/22; H04W 64/00

(57) ABSTRACT

A notification subscription method is performed by a first core network device and includes: subscribing, to a second core network device, a change notification regarding user consent information of a terminal, wherein the user consent information indicates whether the terminal consents to report location information.

### CROSS-REFERENCE TO RELATED APPLICATION

The present application is a U.S. National Stage of International Application No. PCT/CN2022/111939, filed on Aug. 12, 2022, the contents of which are incorporated herein by reference in their entirety.

### TECHNICAL FIELD

The present disclosure relates to the field of communication technologies, and in particular, to a notification subscription method, a subscription determination method, an information receiving method, a notification subscription apparatus, a subscription determination apparatus, an information receiving apparatus, a communication apparatus and a computer-readable storage medium.

### BACKGROUND

In non-terrestrial networks, terminals and base stations may communicate via aerial devices such as satellites. For example, a terminal may send a signal to a satellite, and then the satellite sends it to a base station. Correspondingly, the base station can send a signal to a satellite, and then the satellite sends it to the terminal.

Since the terminal is not in direct communication with the base station, but is in the coverage area of the satellite and communicates with the base station through the satellite, and the coverage area of the satellite is extremely large, the base station generally cannot determine location information of the terminal in this case, and cannot perform some operations that need to be performed according to the location information of the terminal.

### SUMMARY

According to a first aspect of the embodiments of the present disclosure, a notification subscription method is proposed, which is performed by a first core network device, and the method includes: subscribing, to a second core network device, a change notification regarding user consent information of a terminal, where the user consent information indicates whether the terminal consents to report location information.

According to a second aspect of the embodiments of the present disclosure, a subscription determination method is proposed, which is performed by a second core network device, and the method includes: determining that a first core network device subscribes a change notification regarding user consent information of a terminal, where the user consent information indicates whether the terminal consents to report location information.

According to a third aspect of the embodiments of the present disclosure, an information receiving method is proposed, which is performed by a base station, and the method includes: receiving changed user consent information obtained by a first core network device, where the changed user consent information is obtained by the first core network device by subscribing, to a second core network device, a change notification regarding user consent information of a terminal.

### BRIEF DESCRIPTION OF DRAWINGS

A brief introduction will be given below to the accompanying drawings of the present disclosure. The accompanying drawings in the following description are only example embodiments of the present disclosure.

FIG. 1 is a schematic flowchart of a notification subscription method according to an embodiment of the present disclosure.

FIG. 2 is a schematic flowchart of another notification subscription method according to an embodiment of the present disclosure.

FIG. 3 is a schematic flowchart of yet another notification subscription method according to an embodiment of the present disclosure.

FIG. 4 is a schematic flowchart of yet another notification subscription method according to an embodiment of the present disclosure.

FIG. 5 is a schematic flowchart of a subscription determination method according to an embodiment of the present disclosure.

FIG. 6 is a schematic flowchart of another subscription determination method according to an embodiment of the present disclosure.

FIG. 7 is a schematic flowchart of yet another subscription determination method according to an embodiment of the present disclosure.

FIG. 8 is a schematic flowchart of an information receiving method according to an embodiment of the present disclosure.

FIG. 9 is a schematic flowchart of another information receiving method according to an embodiment of the present disclosure.

FIG. 10 is a schematic flowchart of yet another information receiving method according to an embodiment of the present disclosure.

FIG. 11 is a schematic flowchart of a notification subscription method according to an embodiment of the present disclosure.

FIG. 12 is a schematic diagram of multi-party interaction of a notification subscription method according to an embodiment of the present disclosure.

FIG. 13 is a schematic block diagram of a notification subscription apparatus according to an embodiment of the present disclosure.

FIG. 14 is a schematic block diagram of a subscription determination apparatus according to an embodiment of present disclosure.

FIG. 15 is a schematic block diagram of an information receiving apparatus according to an embodiment of the present disclosure.

FIG. 16 is a schematic block diagram of a notification subscription apparatus according to an embodiment of the present disclosure.

FIG. 17 is a schematic block diagram of an apparatus for information reception according to an embodiment of the present disclosure.

### DETAILED DESCRIPTION

Embodiments of the present disclosure will be clearly and completely described below in conjunction with the accompanying drawings. Obviously, the described embodiments are only examples of the embodiments of the present disclosure. Based on the embodiments in the present disclosure, all other embodiments obtained by those of ordinary skills in the art without making creative efforts belong to the protection scope of the present disclosure.

Terms used in embodiments of the present disclosure are only for a purpose of describing specific embodiments, and are not limiting the embodiments of the present disclosure. Singular forms of “a”, said”, and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, these information should not be limited to these terms. These terms are used only to distinguish the same type of information from one another. For example, without departing from the scope of the present disclosure, first information can also be named as second information, and similarly, the second information can also be named as the first information. Depending on the context, the word “if” as used herein can be interpreted as “at” or “when” or “in response to determining”.

For the purpose of simplicity and ease of understanding, the terms used in the present disclosure to represent size relationships are “greater than” or “less than”, “higher than” or “lower than”. But for those skilled in the art, it can be understood that the term “greater than” also covers the meaning of “greater than or equal to” and “less than” also covers the meaning of “less than or equal to”. The term “higher than” covers the meaning of “higher than or equal to” and “lower than” also covers the meaning of “lower than or equal to”.

All embodiments of the present disclosure are mainly applied to non-terrestrial network scenarios. In NTN, a base station communicates with a terminal through a satellite, and a coverage area of the satellite is extremely large, it is difficult for the base station to determine an exact location of the terminal in this case, so there is a need to obtain location information of the terminal.

In a conventional terrestrial network, since the base station communicates directly with the terminal, when the terminal communicates with the base station, the base station may determine that the terminal is within a coverage area of the base station, since the coverage area of the base station is relatively small, and the base station can determine that the location of the terminal is within the coverage area of the base station, so there is no need to obtain location information of the terminal in the terrestrial network.

In the NTN network, after the base station obtains the location information of the terminal, there are various operations that can be performed according to the location information. For example, a first base station can select an appropriate core network access for the terminal according to the location information of the terminal.

For example, the terminal is located near the border between country A and country B. In this case, because of the huge coverage area of the satellite, it covers both the area in country A and the area in country B. However, due to the differences of operators in different countries, it is necessary to connect the terminal located in country A to a core network of operator in country A. When the first base station determines that the terminal is located in country A according to the location information of the terminal, it can select the core network of the operator of country A as the core network for the terminal to access, so as to ensure the terminal to communicate smoothly.

FIG. 1 is a schematic flowchart of a notification subscription method according to an embodiment of the present disclosure. The notification subscription method shown in this embodiment may be performed by a first core network device, the first core network device may be in communication with a base station and a second core network device. The first core network device and the second core network device include, but are not limited to, core network elements in communication systems such as 4G, 5G and 6G. The base station includes, but is not limited to, base stations in communication systems such as 4G, 5G and 6G.

As shown in FIG. 1, the notification subscription method may include the following step.

At step S101, subscribing, to a second core network device, a change notification regarding user consent information of a terminal, where the user consent information indicates whether the terminal consents to report location information.

In an embodiment, the first core network device may include an Access and Mobility Management Function (AMF), and the second core network device may include a Unified Data Management (UDM), and may further include a Unified Data Repository (UDR). The base station may include a Non-Terrestrial Networks-Radio Access Network (NTN-RAN).

In an embodiment, the first core network device, the second core network device and the base station may all store user consent information (or named as user consent preference) of one or more terminals, and the user consent information may indicate whether the terminal consents (agrees) to report (for example, report to the base station) location information. For example, the second core network device may store the user consent information of the terminal as subscription data of the terminal in the UDR.

Further, the first core network device, the second core network device and the base station can store an identification of the terminal in association with the user consent information of the terminal, so as to determine the user consent information of the terminal according to the identification of the terminal, where the identification of the terminal includes but is not limited to a Subscription Permanent Identifier (SUPI), a Subscription Concealed Identifier (SUCI), a Globally Unique Temporary UE Identity (5G-GUTI), an Inactive Radio Network Tempory Identity (I-RNTI), etc.

In an embodiment, the change notification includes at least one of: updating of the user consent information; or revoking of the user consent information.

In an embodiment, the user consent information of the terminal may include whether the user consents to report the location information. The terminal can indicate whether it consents to report the location information by updating the user consent information, or it can indicate that it does not consent to report the location information by revoking the user consent information.

In related technologies, the base station may request from a core network to obtain user consent information of the terminal as needed. In the case where it is determined that the terminal consents to report the location information based on the user consent information fed back from the core network, the base station may send configuration information for reporting the location information to the terminal to obtain the location information reported by the terminal according to the configuration information.

However, the user consent information of the terminal does not always remain unchanged. If the first core network device fails to obtain the current user consent information of the terminal in time, since the user consent information stored in the base station needs to be obtained from the first core network device, which will further lead to the failure of the base station to obtain the current user consent information of the terminal in time, which may lead to the inconsistency between the current user consent information of the terminal and the user consent information stored in the base station, thus causing the base station to send configuration information for reporting location information to the terminal when the terminal does not consent to report location information, resulting in the leakage of terminal's location privacy information and a waste of resources.

According to this embodiment, the first core network device subscribes, to the second core network device, the change notification regarding user consent information of the terminal, so that the second core network device can automatically provide the change notification to the first core network device when it is determined that the stored user consent information of the terminal has changed. So that the first core network device can determine changed (updated) user consent information of the terminal in time, so as to make subsequent operations based on the changed user consent information.

For example, the first core network device may send the changed user consent information to the base station in time, so that the base station can accurately determine the current user consent information of the terminal according to the changed user consent information, and then determine whether it is necessary to provide the terminal with configuration information for reporting location information. This avoids allocating resources to terminals that do not consent to location reporting, thus preventing leakage of location privacy information and wastage of resources.

In an embodiment, the terminal is a designated terminal or a non-designated terminal. The first core network device may subscribe to user consent information of all terminals served by the first core network device stored in the second core network device, or may only subscribe to user consent information of a specific terminal stored in the second core network device. For example, when the first core network device subscribes, to the second core network device, the change notification regarding the user consent information of the terminal, it can provide the second core network device with an identification of the terminal, so that the second core network device can determine which terminal's user consent information the first core network device specifically subscribes to.

In an embodiment, the first core network device may subscribe, to the second core network device, the change notification regarding the user consent information of the terminal via a Nudm_SDM_Subscribe service.

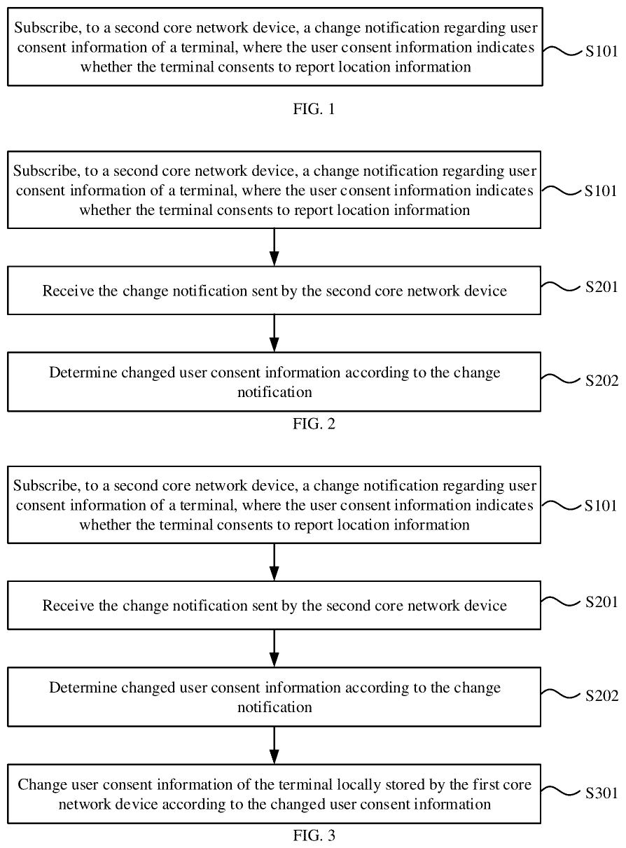

FIG. 2 is a schematic flowchart of another notification subscription method according to an embodiment of the present disclosure. As shown in FIG. 2, the notification subscription method further includes:
at step S201, receiving the change notification sent by the second core network device; and
at step S202, determining changed user consent information according to the change notification.

In an embodiment, the change notification sent by the second core network device may carry the changed user consent information. After receiving the change notification sent by the second core network device, the first core network device may directly parse the received change notification to obtain the changed user consent information carried in the change notification.

In an embodiment, the change notification sent by the second core network device may only be used to indicate that the user consent information of the terminal has changed, and does not carry the changed user consent information. After receiving the change notification sent by the second core network device, the first core network device may determine the changed user consent information according to a preset rule. For example, after receiving the change notification, the first core network device may determine, according to the preset rule, that in the case where the user consent information currently stored by the first core network device is consent (agree), the changed user consent information is non-consent (disagree); and in the case where the user consent information currently stored by the first core network device is non-consent, the changed user consent information is consent. The preset rule may be set by the person skilled in the art according to the need, and the present disclosure does not limit this.

FIG. 3 is a schematic flowchart of yet another notification subscription method according to an embodiment of the present disclosure. As shown in FIG. 3, the notification subscription method further includes:
at step S301, changing user consent information of the terminal locally stored by the first core network device according to the changed user consent information.

In an embodiment, after determining the changed user consent information of the terminal according to the change notification sent by the second core network device, the first core network device may retrieve whether the user consent information of the terminal is included in the context of the terminal locally stored by the first core network device. If the first core network device does not store the user consent information of the terminal locally, the first core network device stores the changed user consent information in the context of the terminal.

If the user consent information of the terminal has been stored in the first core network device, the user consent information of the terminal locally stored in the first core network device can be updated or revoked according to the changed user consent information. For example, the user consent information of the terminal locally stored in the first core network device can be replaced with the changed user consent information.

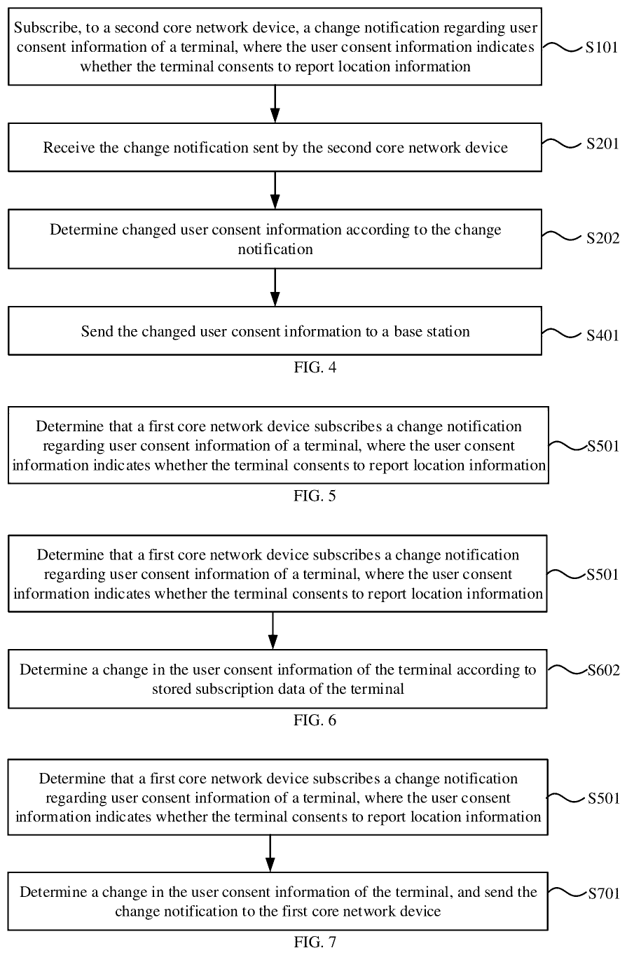

FIG. 4 is a schematic flowchart of yet another notification subscription method according to an embodiment of the present disclosure. As shown in FIG. 4, the notification subscription method further includes:
at step S401, sending the changed user consent information to a base station.

In an embodiment, the first core network device, after determining the changed user consent information of the terminal based on the received change notification, may send the changed user consent information to the base station corresponding to the terminal, so that the base station may be informed of the changed user consent information of the terminal in time, and determine whether the terminal consents to report the location information at present, so as to avoid allocating resources for the terminal to report the location information when the terminal does not consent to report the location information, which may result in leakage of location privacy information and waste of resources.

In an embodiment, the user consent information may be not only used to indicate whether the terminal reports location information, but also to indicate whether the terminal consents to report location information to a specific base station. For example, the terminal may consent to report location information only to some base stations and not to other base stations. Therefore, the change of the user consent information of the terminal may only affect some base stations.

In an embodiment, the first core network device may determine the base station affected by a change in user consent information according to the user consent information before the change and the user consent information after the change, and only needs to send the changed user consent information to the base station affected by the change in the user consent information, without sending the changed user consent information to other base stations, which is beneficial to saving communication resources.

In an embodiment, the change notification further includes base station identification information of a base station affected by a change in the user consent information, and the sending the changed user consent information to a base station includes: sending the changed user consent information to a base station corresponding to the base station identification information.

In addition to determining the base station affected by the change by the first core network device, the second core network device may also determine the base station affected by the change, and directly carry base station identification information of the base station affected by the change in the user consent information in the change notification. After receiving the change notification, the first core network device may send the changed user consent information to the base station corresponding to the base station identification information according to the base station identification information carried in the change notification, without the need to send the changed user consent information to other base stations, which is beneficial for saving communication resources.

For example, for base station a, base station b and base station c, if the user consent information before the change is used to indicate that the user consents to report the location information to base station a, and does not consent to report the location information to base station b and base station c. The changed user consent information is used to indicate that the user consents to report the location information to base station a and base station b, but does not consent to report the location information to base station c. Then the change notification may further include the base station identification information of the base station affected by the change in the user consent information, i.e., base station identification information of base station b. In this case, the first core network device may only send the changed user consent information to the base station b without sending it to the base station a and base station c.

In an embodiment, the first core network device may send an N2 message to the base station, and the changed user consent information is carried in a UE Context Modification Request within the N2 message, so that the base station can determine the changed user consent information according to the context modification request in the N2 message.

FIG. 5 is a schematic flowchart of a subscription determination method according to an embodiment of the present disclosure. The notification subscription method shown in this embodiment may be performed by a second core network device, the second core network device may be in communication with a first core network device and a terminal. The first core network device and the second core network device include, but are not limited to, core network elements in communication systems such as 4G, 5G and 6G. The terminal includes, but is not limited to, a communication apparatus such as a cell phone, a tablet computer, a wearable device, a sensor, an IoT device, and the like.

As shown in FIG. 5, the subscription determination method may include the following step.

At step S501, determining that a first core network device subscribes a change notification regarding user consent information of a terminal, where the user consent information indicates whether the terminal consents to report location information.

In an embodiment, the first core network device may include an AMF, and the second core network device may include a UDM, a UDR, etc. The base station may include an NTN-RAN.

In an embodiment, the first core network device, the second core network device and the base station may all store user consent information of one or more terminals, and the user consent information may indicate whether the terminal consents to report (for example, report to the base station) location information. For example, the second core network device may store the user consent information of the terminal as subscription data of the terminal in the UDR.

Further, the first core network device, the second core network device, and the base station may all store an identification of the terminal, such as a SUPI, a SUCI, a 5G-GUTI, an I-RNTI, etc., in association with the user consent information of the terminal, so as to subsequently determine the user consent information of the terminal based on the identification of the terminal.

In an embodiment, the change notification includes at least one of: updating of the user consent information; or revoking of the user consent information.

In an embodiment, the user consent information of the terminal may include related parameters of whether the user consents to report the location information, base station identification information of a base station corresponding to whether the user consents to report the location information, time information corresponding to whether the user consents to report the location information, etc., and the present disclosure is not limited thereto. The terminal can indicate whether it consents to report location information by updating parameters carried in the user consent information, or it can indicate that it does not consent to report the location information by revoking the user consent information.

In related technologies, the base station may request from a core network to obtain user consent information of the terminal as needed. In the case where it is determined that the terminal consents to report the location information based on the user consent information fed back from the core network, the base station may provide configuration information for reporting the location information to the terminal to obtain the location information reported by the terminal according to the configuration information.

However, the user consent information of the terminal does not always remain the same. If the base station fails to request the current user consent information of the terminal from the core network in time, the actual user consent information of the terminal may be inconsistent with the user consent information stored by the base station. Therefore, there may be a situation where the base station sends configuration information for reporting location information to the terminal when the terminal does not consent to report the location information, resulting in the leakage of the location privacy information of the terminal and the waste of resources.

According to this embodiment, the second core network device may confirm that the first core network device subscribes the change notification regarding the user consent information of the terminal, and actively provide the change notification to the first core network device when it is determined that the stored user consent information of the terminal has changed. So that the first core network device can know the change of the user consent information of the terminal in time, so as to make corresponding feedback for the changed user consent information.

In an embodiment, the terminal is a designated terminal or a non-designated terminal. The first core network device may subscribe to user consent information of all terminals stored in the second core network device, or may only subscribe to user consent information of a specific terminal stored in the second core network device. For example, when the first core network device subscribes, to the second core network device, the change notification regarding the user consent information of the terminal, it can provide the second core network device with an identification of the terminal, so that the second core network device can determine which terminal's user consent information the first core network device specifically subscribes to.

FIG. 6 is a schematic flowchart of yet another subscription determination method according to an embodiment of the present disclosure. As shown in FIG. 6, the subscription determination method further includes:
at step S601, determining a change in the user consent information of the terminal according to stored subscription data of the terminal.

In an embodiment, the second core network device may store the user consent information of the terminal as subscription data of the terminal in the UDR. When the second core network device determines that the subscription data of the terminal has changed, it can determine that the user consent information of the terminal has changed.

FIG. 7 is a schematic flowchart of another subscription determination method according to an embodiment of the present disclosure. As shown in FIG. 7, the subscription determination method further includes:
at step S701, determining a change in the user consent information of the terminal, and sending the change notification to the first core network device.

In an embodiment, based on the subscription of the first core network device, upon determining a change in the user consent information of the terminal, the second core network device can immediately send a change notification to the first core network device, so that the first core network device can determine the changed user consent information in time, and the first core network device can perform operations according to the changed user consent information.

In an embodiment, the second core network device may send the change notification to the first core network device through a Nudm_SDM_Notification service.

In an embodiment, the sending the change notification to the first core network device includes: sending the change notification to a serving core network that provides a service to the terminal according to a core network identifier.

In an embodiment, a correspondence between the terminal and the core network identifier of the serving core network that provides the service to the terminal may be stored in the second core network device. When the second core network device determines that there is a change in user consent information of a certain terminal among the user consent information stored therein, it may determine a core network identifier corresponding to the certain terminal by retrieving the correspondence, and thus may send a change notification to a first core network device corresponding to the core network identifier, so as to notify the first core network device of a change in the user consent parameters of the certain terminal.

In an embodiment, the change notification further includes base station identification information of the base station affected by a change in the user consent information. When the second core network device determines a change in the user consent information of the terminal, it may further determine a base station affected by the change, and carry base station identification information of the base station affected by the change in the user consent information in the change notification. So that after receiving the change notification, the first core network device may send the changed user consent information to the base station corresponding to the base station identification information according to the base station identification information carried in the change notification, without the need to send the changed user consent information to other base stations, which is beneficial for saving communication resources.

For example, for base station a, base station b and base station c, if the user consent information before the change is used to indicate that the user consents to report the location information to base station a, and does not consent to report the location information to base station b and base station c. The changed user consent information is used to indicate that the user consents to report the location information to base station a and base station b, but does not consent to report the location information to base station c, then the second core network device may carry base station identification information of the base station affected by the change in the user consent information, i.e., base station identification information of base station b, in the change notification. So that after receiving the change notification, the first core network device may only send the changed user consent information to the base station b according to the base station identification information carried in the change notification, without the need to send it to base station a and base station c.

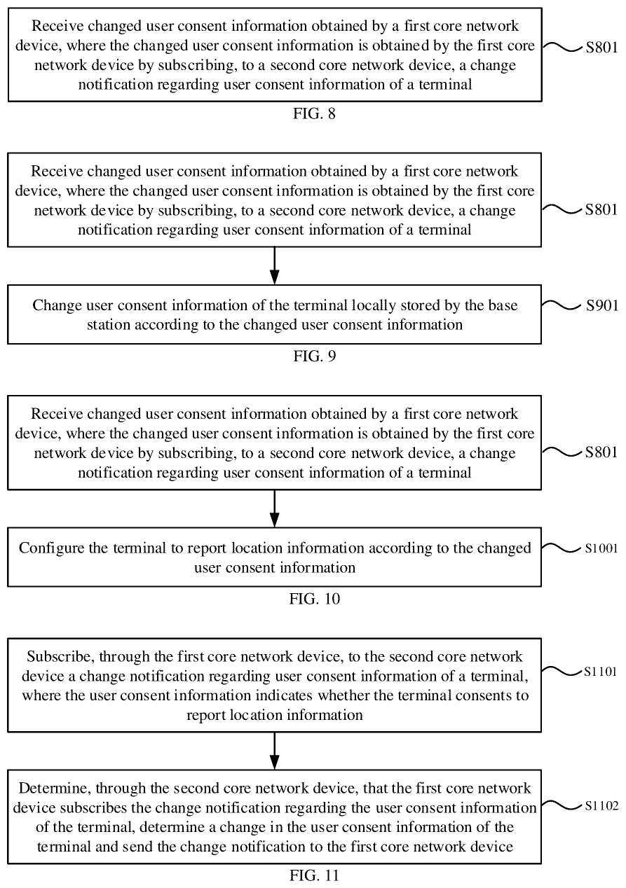

FIG. 8 is a schematic flowchart of an information receiving method according to an embodiment of the present disclosure. The information receiving method shown in this embodiment may be performed by a base station, which may be in communication with a first core network device and a terminal. The base station includes, but is not limited to, base stations in communication systems such as 4G, 5G and 6G. The first core network device includes, but is not limited to, core network elements in communication systems such as 4G, 5G and 6G. The terminal includes, but is not limited to, a communication apparatus such as a cell phone, a tablet computer, a wearable device, a sensor, an IoT device, and the like.

As shown in FIG. 8, the information receiving method may include the following step.

At step S801, receiving changed user consent information obtained by a first core network device, where the changed user consent information is obtained by the first core network device by subscribing, to a second core network device, a change notification regarding user consent information of a terminal.

In related technologies, the base station and the terminal may communicate in a non-terrestrial network (NTN), and the base station may request user consent information of the terminal from the core network at any time as needed. However, the user consent information of the terminal does not always remain the same. If the base station fails to request the user consent information of the terminal from the core network in time, the actual user consent information of the terminal may be inconsistent with the user consent information stored by the base station. Therefore, there may be a situation where the base station sends configuration information for reporting location information to the terminal when the terminal does not consent to report the location information, resulting in the leakage of the location privacy information of the terminal and the waste of resources.

According to this embodiment, since the first core network device subscribes, to the second core network device, the change notification regarding user consent information of the terminal, once the user consent information of the terminal stored in the second core network device changes, the base station may receive the changed user consent information sent by the first core network device after receiving the change notification, and then determine whether it is necessary to send configuration information for reporting location information to the terminal. This avoids allocating resources to terminals that do not consent to location reporting, thus preventing leakage of location privacy information and wastage of resources.

FIG. 9 is a schematic flowchart of another information receiving method according to an embodiment of the present disclosure. As shown in FIG. 9, the information receiving method further includes:
at step S901, changing user consent information of the terminal locally stored by the base station according to the changed user consent information.

In an embodiment, after receiving the changed user consent information of the terminal from the first core network device, the base station may retrieve whether the user consent information of the terminal is included in the context of the terminal locally stored by the base station. If the base station does not store the user consent information of the terminal locally, the base station may store the received updated user consent information, for example, in the context of the terminal.

If the user consent information of the terminal is locally stored in the base station, the user consent information of the terminal stored in the base station can be updated or revoked according to the changed user consent information received from the first core network device, for example, the user consent information of the terminal stored in the base station can be replaced with the changed user consent information received from the first core network device.

In an embodiment, the base station may receive an N2 message sent by the first core network device, and the first core network device may send the changed user consent information in a UE Context Modification Request within the N2 message. After receiving the N2 message, the base station can determine the changed user consent information according to the context modification request in the N2 message.

In an embodiment, the base station, upon receiving the changed user consent information sent by the first core network device, changes (updates) the locally stored user consent information stored in the context of the terminal associated with a temporary terminal identifier (e.g., I-RNTI) to the changed user consent information.

FIG. 10 is a schematic flowchart of yet another information receiving method according to an embodiment of the present disclosure. As shown in FIG. 10, the information receiving method further includes:
at step S1001, configuring the terminal to report location information according to the changed user consent information.

In an embodiment, the configuring the terminal to report location information according to the changed user consent information includes: in response to the updated user consent information indicating that the terminal consents to report location information, sending configuration information for reporting the location information to the terminal; or, in response to the updated user consent information indicating that the terminal does not consent to report location information, not sending configuration information for reporting the location information to the terminal.

When the base station determines that the terminal consents to report the location information according to the changed user consent information, it may send configuration information (e.g., including at least time domain resources and frequency domain resources) for reporting the location information to the terminal, and the terminal may report the location information according to the configuration information; when the base station determines that the terminal does not consent to report the location information according to the changed user consent information, it will not send configuration information for reporting the location information to the terminal, and the terminal will not report the location information.

In an embodiment, the base station may carry the configuration information for the terminal to report the location information in a Radio Resource Control (RRC) configuration message and send it. When the base station determines that the changed user consent information indicates that the user consents to report location information, it can configure resources for the terminal to report location information and send the configuration information for the terminal to report the location information to the terminal in an RRC configuration message, so that the terminal can report the location information according to the configuration information carried in the RRC configuration message after receiving the RRC configuration message.

When the base station determines that the user consent information is revoked according to the changed user consent information, or the updated user consent information indicates that the user does not consent to report the location information, the base station will not carry the configuration information for reporting the location information in the RRC configuration message, so that the terminal can stop reporting the location information after receiving the RRC configuration message that does not carry configuration information for reporting location information.

FIG. 11 is a schematic flowchart of a notification subscription method according to an embodiment of the present disclosure. The notification subscription method shown in this embodiment may be applicable to a core network system and performed by a core network. The core network includes a first core network device and a second core network device, and the first core network device may be in communication with a base station and the second core network device. The base station includes, but is not limited to, base stations in communication systems such as 4G, 5G and 6G. The first core network device includes, but is not limited to, core network elements in communication systems such as 4G, 5G and 6G. The terminal includes, but is not limited to, a communication apparatus such as a cell phone, a tablet computer, a wearable device, a sensor, an IoT device, and the like.

As shown in FIG. 11, the notification subscription method may include the following steps.

At step S1101, subscribing, through the first core network device, to the second core network device a change notification regarding user consent information of a terminal, where the user consent information indicates whether the terminal consents to report location information.

At step S1102, determining, through the second core network device, that the first core network device subscribes the change notification regarding the user consent information of the terminal, determining a change in the user consent information of the terminal and sending the change notification to the first core network device.

The steps performed by the first core network device and the second core network device may be referred to relevant content in the embodiments shown in FIGS. 1 to 7 above and will not be repeated herein.

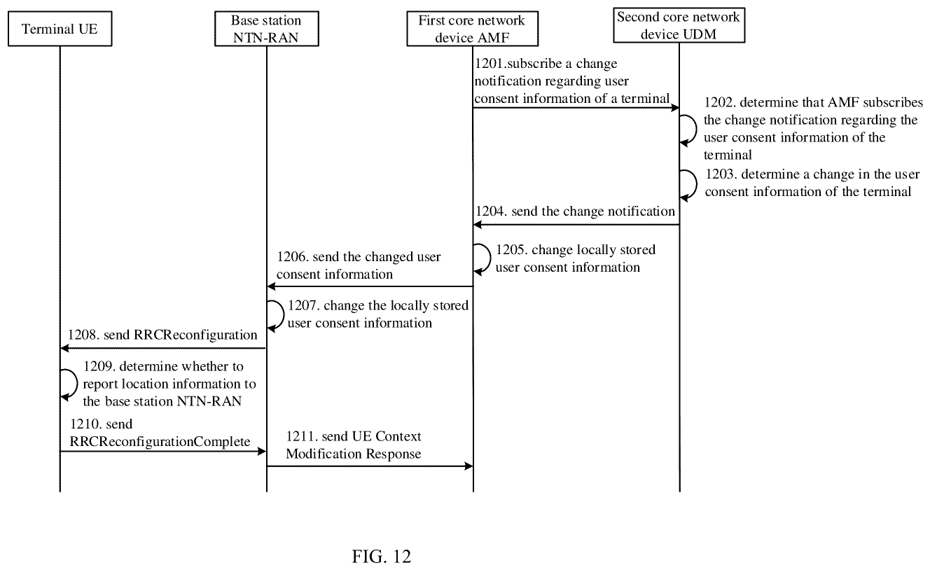

FIG. 12 is a schematic diagram of multi-party interaction of a notification subscription method according to an embodiment of the present disclosure. As shown in FIG. 12, an interaction process among a terminal UE, a base station NTN-RAN, a first core network device AMF and a second core network device UDM includes the following steps.

At step S1201, subscribing, by the first core network device AMF, to the second core network device UDM a change notification regarding user consent information of a terminal, where the user consent information indicates whether the terminal consents to report location information.

At step S1202, the second core network device UDM determines that the first core network device AMF subscribes the change notification regarding the user consent information of the terminal.

At step S1203, the second core network device UDM determines a change in the user consent information of the terminal according to stored subscription data of the terminal.

At step S1204, the second core network device UDM sends the change notification to the first core network device AMF according to the change in the user consent information.

At step S1205, the first core network device AMF determines the changed user consent information according to the received change notification, and changes locally stored user consent information according to the changed user consent information.

At step S1206, the first core network device AMF sends the changed user consent information to the base station NTN-RAN.

At step S1207, the base station NTN-RAN changes the locally stored user consent information according to the received changed user consent information.

Upon receiving the changed user consent information sent by the first core network device AMF, the base station NTN-RAN may save the changed user consent information in the user context of the terminal, and then the base station may determine how to configure the terminal based on the changed user consent information of the terminal.

At step S1208, the base station NTN-RAN sends a radio resource control reconfiguration (RRCReconfiguration) message to the terminal UE according to the changed user consent information.

When determining that the terminal consents to report location information according to the changed user consent information, the base station may carry configuration information used for reporting location information in the RRCReconfiguration message and send it to the terminal. When determining that the terminal does not consent to report location information according to the changed user consent information, the base station will not send configuration information used for reporting location information to the terminal.

At step S1209, the terminal determines whether to report location information to the base station NTN-RAN according to the received RRCReconfiguration message.

The terminal reports the location information to the base station NTN-RAN according to the configuration information for reporting location information when determining that the RRCReconfiguration message carries the configuration information for reporting the location information. The terminal stops reporting the location information to the base station NTN-RAN when determining that the RRCReconfiguration message does not carry the configuration information for reporting the location information.

At step S1210, the terminal may send a radio resource control reconfiguration complete (RRCReconfigurationComplete) message to the base station.

At step S1211, the base station NTN-RAN sends an N2 message to the first core network device AMF, which may carry a UE Context Modification Response.

Corresponding to the foregoing embodiments of the notification subscription method, the subscription determination method, the information receiving method, and the notification subscription method, the present disclosure further provides embodiments of the notification subscription apparatus, the subscription determination apparatus, the information receiving apparatus, and the notification subscription apparatus.

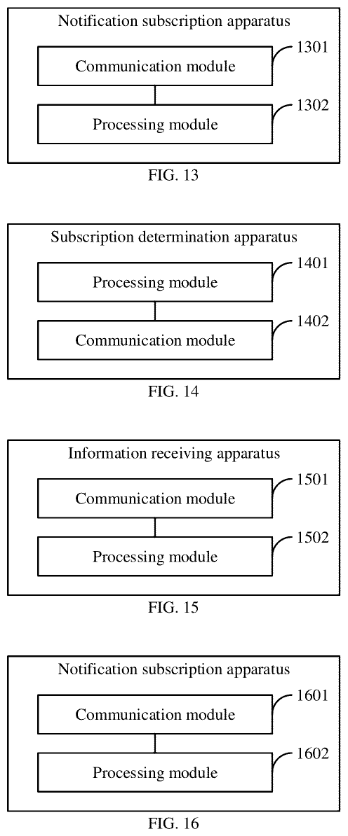

FIG. 13 is a schematic block diagram of a notification subscription apparatus according to an embodiment of the present disclosure. The notification subscription apparatus shown in this embodiment may be applied to a first core network device, the first core network device may be in communication with a base station and a second core network device. The first core network device and the second core network device include, but are not limited to, core network elements in communication systems such as 4G, 5G and 6G. The base station includes, but is not limited to, base stations in communication systems such as 4G, 5G and 6G.

As shown in FIG. 13, the notification subscription apparatus may include:
a communication module 1301, configured to subscribe, to a second core network device, a change notification regarding user consent information of a terminal, where the user consent information indicates whether the terminal consents to report location information.

In an embodiment, the change notification includes at least one of: updating of the user consent information; or revoking of the user consent information.

In an embodiment, the communication module is further configured to: receive a change notification sent by the second core network device, the apparatus further includes: a processing module 1302, configured to determine changed user consent information according to the change notification.

In an embodiment, the processing module is further configured to change, according to the changed user consent information, locally stored user consent information.

In an embodiment, the communication module is further configured to: send the changed user consent information to a base station.

In an embodiment, the change notification further includes base station identification information of a base station affected by a change in the user consent information, and the communication module is configured to: send the changed user consent information to a base station corresponding to the base station identification information.

In an embodiment, the terminal is a designated terminal or a non-designated terminal.

FIG. 14 is a schematic block diagram of a subscription determination apparatus according to an embodiment of present disclosure. The subscription determination apparatus shown in this embodiment may be applied to a second core network device, the second core network device may be in communication with a first core network device and a terminal. The first core network device and the second core network device include, but are not limited to, core network elements in communication systems such as 4G, 5G and 6G. The terminal includes, but is not limited to, a communication apparatus such as a cell phone, a tablet computer, a wearable device, a sensor, an IoT device, and the like.

As shown in FIG. 14, the subscription determination apparatus may include:
a processing module 1401, configured to determine that a first core network device subscribes a change notification regarding user consent information of a terminal, where the user consent information indicates whether the terminal consents to report location information.

In an embodiment, the apparatus further includes: a communication module 1402, configured to determine a change in the user consent information of the terminal, and send the change notification to the first core network device.

In an embodiment, the communication module is configured to: send, according to a core network identifier, the change notification to a serving core network that provides a service to the terminal.

In an embodiment, the processing module is further configured to: determine, according to stored subscription data of the terminal, a change in the user consent information of the terminal.

FIG. 15 is a schematic block diagram of an information receiving apparatus according to an embodiment of the present disclosure. The information receiving apparatus shown in this embodiment may be applied to a base station, which may be in communication with a first core network device and a terminal. The base station includes, but is not limited to, base stations in communication systems such as 4G, 5G and 6G. The first core network device includes, but is not limited to, core network elements in communication systems such as 4G, 5G and 6G. The terminal includes, but is not limited to, a communication apparatus such as a cell phone, a tablet computer, a wearable device, a sensor, an IoT device, and the like.

As shown in FIG. 15, the information receiving apparatus may include:
a communication module 1501, configured to receive changed user consent information obtained by a first core network device, where the changed user consent information is obtained by the first core network device by subscribing, to a second core network device, a change notification regarding user consent information of a terminal.

In an embodiment, the apparatus further includes: a processing module 1502 configured to change, according to the changed user consent information, locally stored user consent information.

In an embodiment, the communication module is further configured to configure the terminal to report location information according to the changed user consent information.

FIG. 16 is a schematic block diagram of a notification subscription apparatus according to an embodiment of the present disclosure. The notification subscription apparatus shown in this embodiment may be applicable to a core network system and applied to a core network. The core network includes a first core network device and a second core network device, and the first core network device may be in communication with a base station and the second core network device. The base station includes, but is not limited to, base stations in communication systems such as 4G, 5G and 6G. The first core network device includes, but is not limited to, core network elements in communication systems such as 4G, 5G and 6G. The terminal includes, but is not limited to, a communication apparatus such as a cell phone, a tablet computer, a wearable device, a sensor, an IoT device, and the like.

As shown in FIG. 16, the notification subscription apparatus may include:
a communication module 1601, configured to subscribe, through the first core network device, to the second core network device a change notification regarding user consent information of a terminal, where the user consent information indicates whether the terminal consents to report location information; and
a processing module 1602, configured to determine, through the second core network device, that the first core network device subscribes the change notification regarding the user consent information of the terminal, determine a change in the user consent information of the terminal and send the change notification to the first core network device.

Regarding to the apparatus in the above embodiment, a specific way in which each module performs operations has been described in detail in the embodiment of related methods, and will not be described in detail here.

For the apparatus embodiments, because they basically correspond to the method embodiments, it is only necessary to refer to the method embodiments for the relevant part of the description. The apparatus embodiments described above are only schematic, where the modules described as separate components may or may not be physically separated, and the components displayed as modules may or may not be physical modules, that is, they may be located in one place or distributed to a plurality of network modules. Some or all of the modules can be selected according to actual needs to achieve the purpose of this embodiment. It can be understood and implemented by a person of ordinary skill in the art without creative labor.

An embodiment of the present disclosure further provides a communication apparatus, including: a processor; and a memory for storing a computer program; where the notification subscription method described in any of the above embodiments is implemented when the computer program is executed by the processor.

An embodiment of the present disclosure further provides a communication apparatus, including: a processor; and a memory for storing a computer program; where the subscription determination method described in any of the above embodiments is implemented when the computer program is executed by the processor.

An embodiment of the present disclosure further provides a communication apparatus, including: a processor; and a memory for storing a computer program; where the information receiving method described in any of the above embodiments is implemented when the computer program is executed by the processor.

An embodiment of the present disclosure further provides a computer-readable storage medium for storing a computer program, which, when executed by a processor, realizes the steps in the notification subscription method described in any of the above embodiments.

An embodiment of the present disclosure further provides a computer-readable storage medium for storing a computer program, which, when executed by a processor, realizes the steps in the subscription determination method described in any of the above embodiments.

An embodiment of the present disclosure further provides a computer-readable storage medium for storing a computer program, which, when executed by a processor, realizes the steps in the information receiving method described in any of the above embodiments.

An embodiment of the present disclosure further provides a core network system, which includes a first core network device and a second core network device, where: the first core network device is configured to subscribe, through the first core network device, to the second core network device a change notification regarding user consent information of a terminal, where the user consent information indicates whether the terminal consents to report location information; and the second core network device is configured to determine, through the second core network device, that the first core network device subscribes the change notification regarding the user consent information of the terminal, determine a change in the user consent information of the terminal and send the change notification to the first core network device.

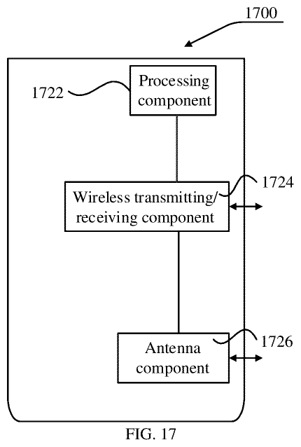

As shown in FIG. 17, FIG. 17 is a schematic block diagram of an apparatus 1700 for information reception according to an embodiment of the present disclosure. The apparatus 1700 may be provided as a base station. Referring to FIG. 17, the apparatus 1700 includes a processing component 1722, a wireless transmitting/receiving component 1724, an antenna component 1726, and a signal processing part unique to a wireless interface, and the processing component 1722 may further include one or more processors. One of the processors in the processing component 1722 may be configured to implement the information receiving method described in any of the above embodiments.

Other embodiments of the present disclosure will easily occur to those skilled in the art after considering the specification and practicing the disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

It should be noted that, relational terms here such as first and second are only used to distinguish one entity or operation from another entity or operation, and do not necessarily require or imply that there is any such actual relationship or order between these entities or operations. Terms “including”, “containing” or any other variations thereof are intended to cover non-exclusive inclusion, so that a process, method, object or device including a series of elements not only includes those elements, but also includes other elements not explicitly listed or elements inherent to such process, method, object or device. Without further limitations, an element defined by the phrase “including one” does not exclude the existence of other identical elements in the process, method, object or device including the element.

The methods and apparatuses of the present disclosure are described above in detail. The principle and implementation of the present disclosure are described herein through specific examples. The description about the embodiments of the present disclosure is merely provided for ease of understanding of the method and core ideas of the present disclosure. Persons of ordinary skill in the art can make variations and modifications to the present disclosure in terms of the specific implementations and application scopes according to the ideas of the present disclosure. Therefore, the specification shall not be construed as a limit to the present disclosure.

1. A notification subscription method, performed by a first core network device and comprising:
subscribing, to a second core network device, a change notification regarding user consent information of a terminal, wherein the user consent information indicates whether the terminal consents to report location information.

2. The method according to claim 1, wherein the change notification comprises at least one of:
updating of the user consent information; or
revoking of the user consent information.

3. The method according to claim 1, further comprising:
receiving the change notification sent by the second core network device; and
determining changed user consent information according to the change notification.

4. The method according to claim 3, further comprising:
updating user consent information of the terminal locally stored by the first core network device to the changed user consent information.

5. The method according to claim 3, further comprising:
sending the changed user consent information to a base station.

6. The method according to claim 5, wherein the change notification further comprises base station identification information of a base station affected by a change in the user consent information, and the sending the changed user consent information to a base station comprises:
sending the changed user consent information to a base station corresponding to the base station identification information.

7. A subscription determination method, performed by a second core network device and comprising:
determining that a first core network device subscribes a change notification regarding user consent information of a terminal, wherein the user consent information indicates whether the terminal consents to report location information.

8. The method according to claim 7, further comprising:
determining the change notification based on a change in the user consent information of the terminal, and
sending the change notification to the first core network device.

9. The method according to claim 8, wherein the sending the change notification to the first core network device comprises:
sending, according to a core network identifier, the change notification to a serving core network that provides a service to the terminal.

10. The method according to claim 8, further comprising:
determining, according to stored subscription data of the terminal, the change in the user consent information of the terminal.

11. An information receiving method, performed by a base station and comprising:
receiving changed user consent information from a first core network device, wherein user consent information indicates whether a terminal consents to report location information, and the changed user consent information is obtained by the first core network device by subscribing, to a second core network device, a change notification regarding user consent information of the terminal.

12. The method according to claim 11, further comprising:
updating user consent information of the terminal locally stored by the base station to the changed user consent information.

13. The method according to claim 11, further comprising:
configuring, according to the changed user consent information, the terminal to report location information.

14.-28. (canceled)

29. A communication apparatus, comprising:
a processor; and
a memory for storing a computer program executable by the processor;
wherein the processor is configured to perform the method according to claim 1.

30. A non-transitory computer-readable storage medium for storing a computer program, wherein the computer program, when executed by a processor, causes the processor to perform the method according to claim 1.

31. A communication apparatus, comprising:
a processor; and
a memory for storing a computer program executable by the processor;
wherein the processor is configured to perform the method according to claim 7.

32. A non-transitory computer-readable storage medium for storing a computer program, wherein the computer program, when executed by a processor, causes the processor to perform the method according to claim 7.

33. A communication apparatus, comprising:
a processor; and
a memory for storing a computer program executable by the processor;
wherein the processor is configured to perform the method according to claim 11.

34. A non-transitory computer-readable storage medium for storing a computer program, wherein the computer program, when executed by a processor, causes the processor to perform the method according to claim 11.

35. (canceled)
